(19) United States
(12) Patent Application Publication
(10) Pub. No.: US 2003/0016651 A1
(43) Pub. Date: Jan. 23, 2003

(54) System architecture and method for increasing the capacity and speed of bluetooth access points

(76) Inventors: Yu Kwong Kwok, Hong Kong (CN); Wai Yin Chu, Hong Kong (CN); Sai Weng Lei, Hong Kong (CN); Wen Cheng Chung, Hong Kong (CN); Chiu Wa Ng, Hong Kong (CN); Chun Yi Lee, Hong Kong (CN); Kin Nang Lau, Hong Kong (CN)

Correspondence Address: HENRICKS SLAVIN AND HOLMES LLP, SUITE 200, 840 APOLLO STREET, EL SEGUNDO, CA, 90245

(21) Appl. No.: 09/825,312

(22) Filed: Apr. 2, 2001

(51) Int. Cl. H04J 3/24

(52) U.S. Cl. 370/349

(57) ABSTRACT

A system architecture for facilitating wireless communications includes a processor configured to implement interference avoidance processing and interference control processing for one or more groups of devices of a packet-communications system. The interference avoidance processing provides different addresses and a common clock for each of the groups of devices to minimize a frequency collision probability for the devices. The interference control processing detects when a same frequency element is selected for more than one of the devices for a same time slot and implements rescue processing to save data packets that are going to collide from being lost. In a preferred embodiment, the interference avoidance processing includes choosing particular address bits to provide the different addresses. In a preferred embodiment, the rescue processing is performed in consideration of a packet importance indicator which relates to one or more of: packet type, service type, a fairness criterion, and a history of prior connections made.

### BACKGROUND OF THE INVENTION

1. Field of Invention

The present invention relates generally to a system architecture and method for facilitating wireless communications between devices and, more specifically, to a system architecture and method for increasing the capacity and speed of Bluetooth access points.

2. Description of the Related Art

Bluetooth™ (BT) is a short-range wireless technology for rapid and dynamic interconnection between handheld devices. One of the major applications of Bluetooth is convenient and fast Internet access via a fixed-line infrastructure 100, as illustrated in FIG. 1, for both the residential and indoor public areas. In FIG. 1, a standard BT hub 102 and a plurality of standard BT devices 104, 106, 108, 110 are shown.

The current implementation of Bluetooth supports a maximum of seven slaves in a piconet or Personal-Area Network (PAN), and the aggregate bit rate is 723 kbps in one direction. However, this implementation has shortcomings. The number of BT devices supported in the conventional piconet is very limited. Furthermore, the quality of transmission of real time video is not very good due to the limited transmission bit rate. If the piconet contains 7 active Bluetooth devices, the maximum data rate per user would be 57.6 kbps only. The capacity and speed limitations of this implementation of Bluetooth potentially present a serious bottleneck to supporting access point capability, such as in residential areas or public areas (e.g., hotels, airports).

Bluetooth employs frequency hopping whereby data packets are transmitted using different frequencies at different times. Within a piconet, the hopping frequency is coordinated by the BT-master and, hence, interference among the slaves (of a particular BT-master) is avoided. The changing hopping frequency of a BT device can be described by a hopping sequence. BT devices belonging to the same piconet follow the same hopping sequence, which is determined by the BT-master address and the master clock counter.

Although different piconets operate at different hopping sequences (because they have different BT master addresses and clock phases), their hopping frequencies can at times be the same resulting in packet collisions when several (more than one) piconets are operating nearby. For example, when two nearby piconets (at the vicinity of the access point) transmit or listen at the same frequency at a given time, packets or time slot data are corrupted or lost as a result of in-band interference.

Referring to FIG. 3, the numbers in the exemplary hopping frequency sequences represent the frequencies that Piconets 1-4 occupy over time. The shaded numbers represent collisions; for instance, all two or three of the packets at those specific time slots will be corrupted and there will be a failure in transmitting data. Thus, a significant problem with operating several piconets nearby is the potential for interference.

As shown in the following table, the probability of collision increases as the number of piconets operating nearby is increased:

| Number of piconets | Crashing percentage |
|---|---|
| 2 | 2.74% |
| 3 | 7.78% |
| 4 | 15.36% |

When more than four piconets are operating freely, the problem is even more serious.

It would be helpful to be able to minimize or lessen the probability of such collisions and enhance the capacity of Bluetooth access points. It would also be helpful to be able to enhance the capacity (number of slaves) of BT-hubs for access points and to increase the data rate of the access so that high quality video transmission can be realized.

### SUMMARY OF THE INVENTION

The present invention generally pertains to a system architecture and method for coordinating the BT-masters of BT-piconets in the vicinity of an access point. The present invention provides an access point that supports generic BT devices, but the number of BT devices supported by the access point is significantly (e.g., at least 10 times) larger than conventional BT access points. By way of example, the maximum transmission speed per BT-device according to the system architecture and method of the present invention is 723 kbps even if the access point is loaded with other BT devices.

A high-capacity BT hub is achieved according to the principles of the present invention via a system architecture through which interference avoidance processing and/or interference control processing are implemented. Referring to FIG. 2, a multi-piconet configuration 200 according to the present invention includes a high capacity hub 202 and a plurality of standard BT devices 204, 206, 208 configured as a plurality of piconets (in this example, BT-piconets A, B, C). Generally, the high capacity hub 202 serves to synchronize operation of the plurality of BT piconets

The multiple piconets are created at the vicinity of the access point; and an exemplary preferred multi-piconet configuration satisfies several requirements. For one, the time slots of the piconets are synchronized. Also, the access point should be able to respond sufficiently fast to the discovery of new client BT devices in its range. Another requirement is that interference is controlled and/or minimized.

In a preferred embodiment of the present invention, an Interference Avoidance Algorithm (interference avoidance processing) is employed to minimize or lessen the chance of collisions between packets of different piconets. More specifically, by employing specially selected BT_ADDRs and the same clock, the piconets are provided with hopping frequency sequences such as those illustrated in FIG. 4 which results in significantly lowering the collision rate.

Although the chance of frequency collision is minimized or lessened as a result of the interference avoidance processing, there are still chances of having frequency collisions because the hopping sequence defined in the BT standard is not orthogonal. Accordingly, in a preferred embodiment of the present invention, an Interference Control Algorithm (interference control processing) is employed to control the effect of interference when a collision actually occurs. This is accomplished by inhibiting the transmission of packets in all-but-one piconet during the collision time slot. In an exemplary preferred embodiment, the choice of the piconet to transmit is determined by a scheduling component which takes into account Quality-of-Service (QoS) requirements of different connections as well as fairness criteria.

A system architecture for facilitating wireless communications, in accordance with an embodiment of the present invention, includes a processor configured to implement interference avoidance processing and interference control processing for one or more groups of devices of a packet-communications system. The interference avoidance processing provides different addresses and a common clock for each of the groups of devices to minimize a frequency collision probability for the devices. The interference control processing detects when a same frequency element is selected for more than one of the devices for a same time slot and implements rescue processing to save data packets that are going to collide from being lost. In a preferred embodiment, at least one of the groups of devices is a piconet. In a preferred embodiment, the interference avoidance processing includes choosing particular address bits to provide the different addresses. In a preferred embodiment, the rescue processing is performed in consideration of a packet importance indicator which relates to one or more of: packet type, service type, a fairness criterion, and a history of prior connections made. In a preferred embodiment, the packet-communication system is a spread-spectrum, frequency-hopping, short-range packet-communications system. In a preferred embodiment, the packet-communication system is compatible with the Bluetooth standard. In a preferred embodiment, the packet-communication system is capable of operating in the 2.4-Gbit industrial, scientific and medical (ISM) band.

A method for facilitating wireless communications between devices, in accordance with another embodiment of the present invention, includes the step of: controlling hopping frequency generators for a plurality of groups of communication devices within range of each other to generate hopping frequency sequences for the groups of communications devices by providing the same clock values and different addresses to the hopping frequency generators. In a preferred embodiment, only particular address bits are chosen to provide the different addresses. In a preferred embodiment, the particular address bits comprise A_{1,3,5,7,9}.

A method for facilitating wireless communications between devices, in accordance with another embodiment of the present invention, includes the steps of: determining when frequency collisions will occur for a plurality of groups of communication devices within range of each other; and inhibiting transmission of packets in all but one of the groups of communication devices during a collision time slot. In a preferred embodiment, the step of inhibiting transmission of packets is performed in consideration of a packet importance indicator. The packet importance indicator relates, for example, to packet type, service type and/or a fairness criterion. In a preferred embodiment, the fairness criterion includes a history of prior connections made. In a preferred embodiment, the packet importance indicator is tuned.

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 illustrates wireless Internet access via a conventional Bluetooth hub;

FIG. 2 illustrates an exemplary high capacity hub that incorporates the principles of the present invention;

FIG. 3 illustrates exemplary hopping frequency sequences of conventional piconets;

FIG. 4 illustrates exemplary hopping frequency sequences according to the present invention;

FIG. 5 is a flowchart illustrating interference control processing according to an exemplary preferred embodiment of the present invention;

FIG. 6 illustrates an exemplary overall architecture for a high capacity hub according to the present invention;

FIG. 7 is a plot of simulation results for the frequency collision probability for different numbers of piconets in connection state with different masters in page or inquiry state;

FIG. 8 is a diagram which illustrates the general flow of interference control processing according to an embodiment of the present invention; and

FIG. 9 illustrates how a packet collision is predicted for activating a rescue process according to the present invention.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

Overall Architecture of the High Capacity Hub.

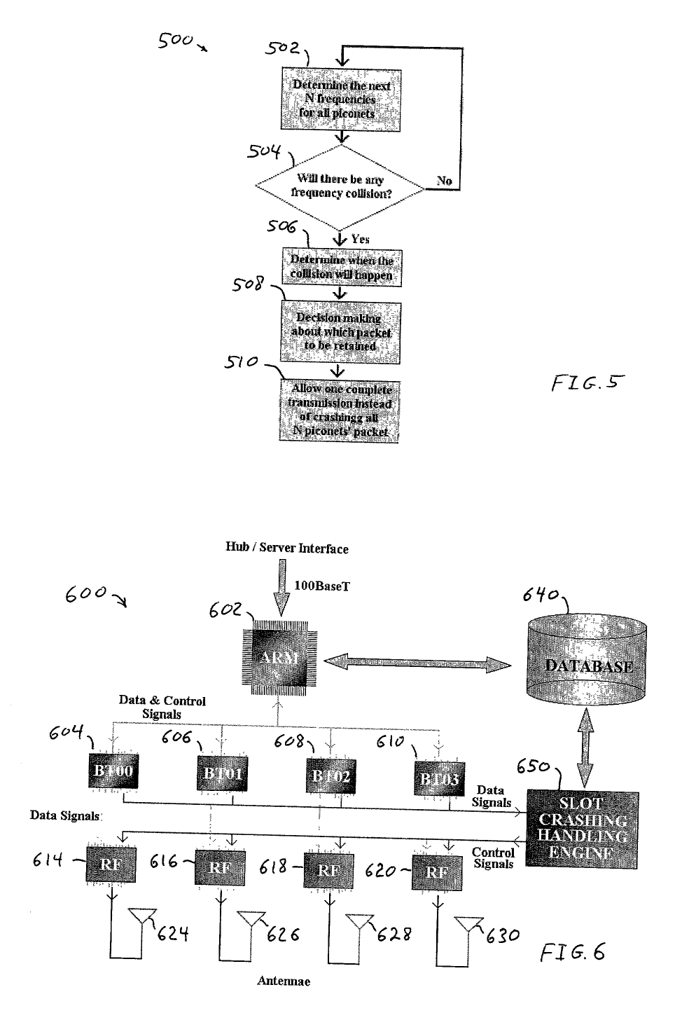

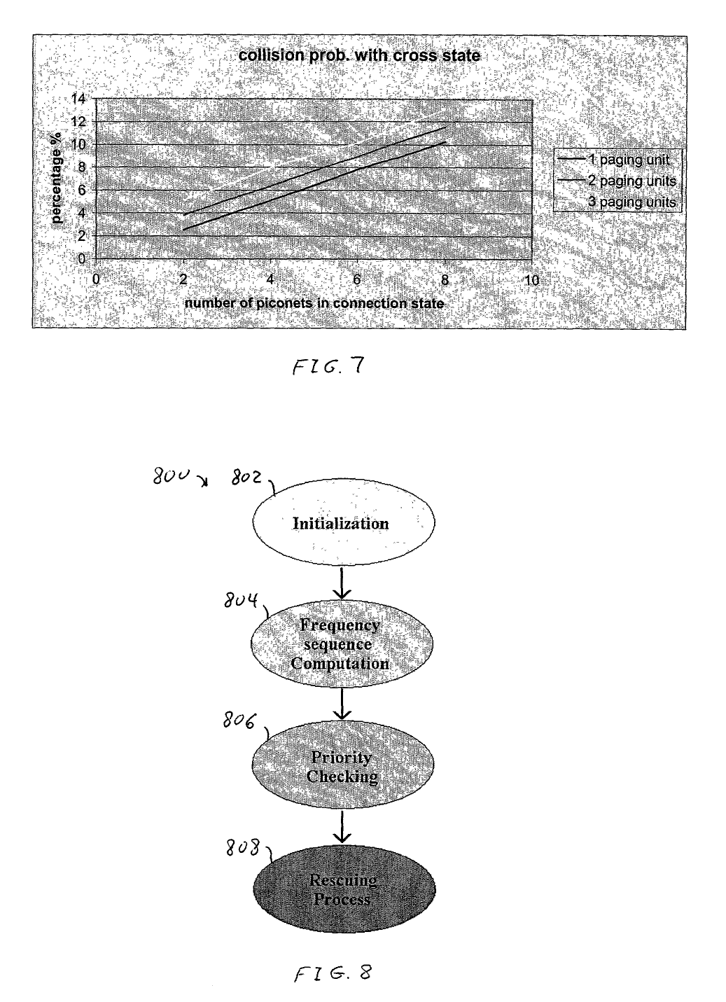

Referring to FIG. 6, an exemplary overall architecture 600 for a high capacity hub according to the present invention is illustrated. The hub architecture 600 includes a processor 602, a plurality of BT devices 604, 606, 608, 610, a plurality of RF interface devices 614, 616, 618, 620, antennae 624, 626, 628, 630, a database 640, and a slot crashing handling engine 650 configured as shown. In a preferred embodiment, the architecture 600 is realized in an embedded system and the processor 602 comprises an ARM® core or DSP which drives the BT devices 604, 606, 608, 610. Although four BT devices (BT00-BT03) are shown in FIG. 6, it should be understood that the principles of the present invention are applicable to architectures with a lesser or greater number of devices and to devices other those that comply with the Bluetooth Specification. Other processors can also be employed.

In the exemplary overall architecture 600, each BT device has its own RF interface so that interference control can be implemented in a direct manner. The database 640 of the system is employed to store information relevant to network connections, data transfer, etc. In order to communicate with other hubs or servers, a 100baseT (or other) interface is provided. In order to synchronize all the transmission and reception times of the BT devices 604, 606, 608, 610, the devices are driven by the same clock.

In operation, the processor 602 controls the BT devices (BT00-BT03) through Host Controller Interface (HCI) commands as defined in the Bluetooth Specification—which is incorporated herein by reference in its entirety. In a preferred embodiment, one of the BT devices, e.g., BT00, is dedicated for searching new comers or finding any users nearby and is configured in inquiry state. The BT device can allow quick response to new comers and periodically queries any nearby BT devices. When there is a response, BT00 stores the identification information, e.g., BT_ADDR and other information, in the database 640. Based on the information stored in the database, the ARM core issues HCI connection commands to the other three BT devices to facilitate link connections between the hub and the user. The ARM core or DSP coordinates resources according to information stored in the database. Once a connection is established, data can be transferred between the server and user side. The ARM core or DSP also inspects the network usage. An advantage of this configuration is that the total bandwidth available for data transfer is enlarged by the number of serving BT devices in the hub. When there are only a few users, e.g., less than four users, each user will be connected to different BT units in the hub. This allows each user to enjoy the full capacity of the BT network. When there are more users, each of the BT units in the hub can connect up to seven devices. Accordingly, the hub of the present invention then can handle many more users than a single BT master.

Generally, the slot crashing handling engine 650 is configured to detect when two BT devices may interfere with each other. It then issues appropriate control signals to the RF interfaces 614, 616, 618, 620 so that only one device is allowed to transmit at a time. The device that is inhibited from transmitting is controlled to wait for a timeout period before retransmission occurs. An avoidance interference scheme according to the present invention is described below.

Interference Avoidance Algorithm (Processing)

In order to minimize or lessen the probability of collisions, and thus to boost hub capacity, an interference avoidance scheme according to the present invention is implemented whereby sets of BT_ADDRs are generated which result in a very low or virtually zero frequency collision probability. More specifically, by employing specially selected BT_ADDRs and the same clock, hopping frequency sequences such as those illustrated in FIG. 4 are generated. Moreover, all of the devices operate in a synchronized mode such that they have the same frame boundary.

Within the previously discussed exemplary hub, the four piconets are handled by four BT devices with specially selected addresses. The BT_ADDRs of the devices are 32-bit long. According to an exemplary preferred embodiment of the present invention, to maintain the best performance, the bit pattern of those selected addresses belonging to the same set must satisfy:

| 31 | 30 | 29 | 28 | 27 | 26 | 25 | 24 | 23 | 22 | 21 | 20 | 19 | 18 | 17 | 16 | 15 | 14 | 13 |
|---|---|---|---|---|---|---|---|---|---|---|---|---|---|---|---|---|---|---|
| S | S | S | S | S | S | S | S | S | S | S | S | S | S | S | S | S | S | S |

| 12 | 11 | 10 | 9 | 8 | 7 | 6 | 5 | 4 | 3 | 2 | 1 | 0 |
|---|---|---|---|---|---|---|---|---|---|---|---|---|
| S | S | S | X | S | X | S | X | S | X | S | X | S |

where the first row indicates the bit position of the BT_ADDR and the second row indicates the bit content. Those bits indicated with “S” content must be the same in all the elements of the same set, while an “X” indicates a “don't care” condition. For instance, each set consists of 32 elements at most under the assumption that the clock values of all the piconets are the same. By way of example, the following addresses belong to the same set:

address[0]=0x2A96ED05; (note: 0x means Hex code format)

address[l]=0x2A96ED07;

address[2]=0x2A96ED0D;

address[3]=0x2A96ED0F;

address[4]=0x2A96ED25;

address[5]=0x2A96ED27;

. . .

Thus, for the previously discussed exemplary hub, four out of the whole set of addresses can be chosen to build a high capacity hub according to the present invention.

In a preferred embodiment, the hopping frequency sequences are generated by employing a hopping frequency generator such as the one disclosed in FIG. 11.3 of the Specification of the Bluetooth System volume 1, incorporated herein by reference. To maintain a virtually zero collision rate, the hopping frequency generators run dependently. In an exemplary preferred embodiment, the generators of different piconets/masters have the same clocks, the specially selected BT_ADDRs, and the same state of operation (i.e., connection, inquiry, page, response state). The inputs K, F and Y2 for the “ADD” block in FIG. 11.3 are the same for all generators; and the input E is the only input that is different in different generators. The value of E is the BT_ADDR odd bits from bit 1 to bit 13; once the addresses of the devices are set, it will not be changed. To ensure input Ks are the same, A_{1,3,5,7,9} are the bits left that can be chosen arbitrarily. In this exemplary preferred embodiment, 32 piconets can operate within range with zero collision rates provided the generators have the same clocks, the specially selected BT_ADDRs, and the same state of operation. A virtually zero collision rate is thus achievable for piconets which are mainly in connection state. With the present invention, the number of inputs can be decreased significantly as well as the computation time, as compared to the conventional approach where four devices need to input four different 28-bit addresses, four different 32-bit native clock values and four 4-bit mode identifications.

Even with the proposed hopping frequency sequence selection strategy, collision may still occur due to state crossing, e.g., BT01 is in inquiry state while BT02 is in paging state. Such collisions cause corruption of the information that is transmitting for the entire collided time slot. That is, if three piconets are trying to transmit in the same frequency, all three packets will be lost.

The following table sets forth simulation results (which are plotted in FIG. 7) for the frequency collision probability for different numbers of piconets in connection state with different masters in page or inquiry state.

| | Collision | Collision | Collision |
|---|---|---|---|
| | probability in | probability | probability in |
| Number of piconets in | % (with 1 | in % (with 2 | % (with 3 |
| connection state. | paging unit) | paging units) | paging units) |
| 2 | 2.54 | 3.8 | 5.15 |
| 3 | 3.82 | 5.15 | 6.45 |
| 4 | 5.1 | 6.35 | 7.95 |
| 5 | 6.4 | 7.69 | 9.12 |
| 6 | 7.8 | 8.92 | 10.14 |
| 7 | 8.96 | 10.32 | 11.6 |
| 8 | 10.28 | 11.52 | 13.1 |

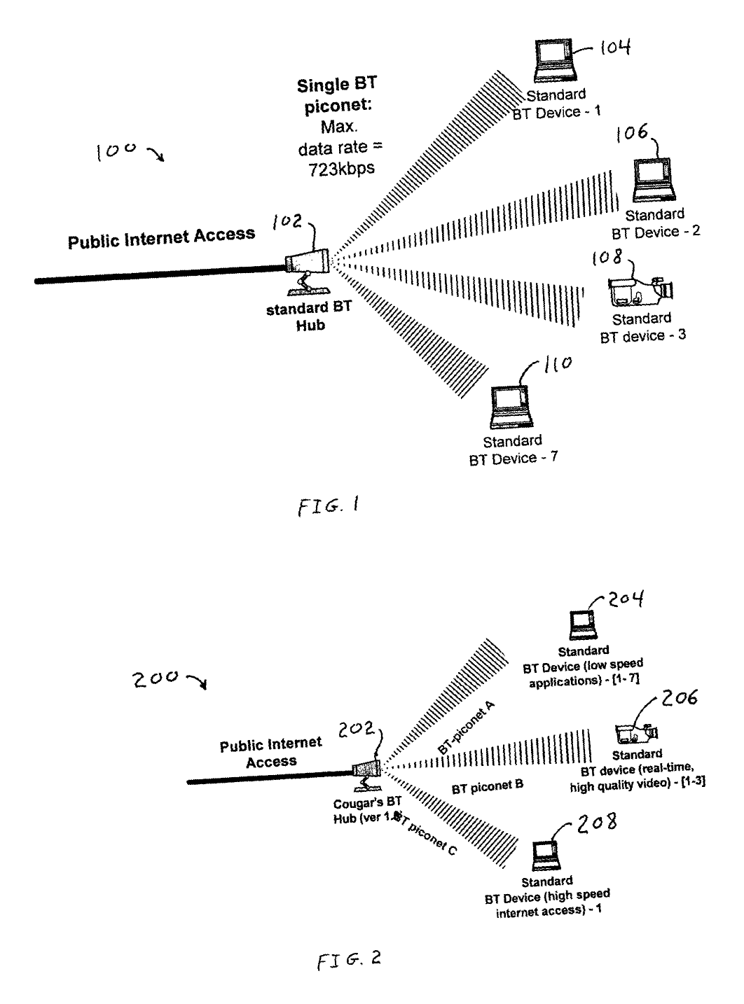

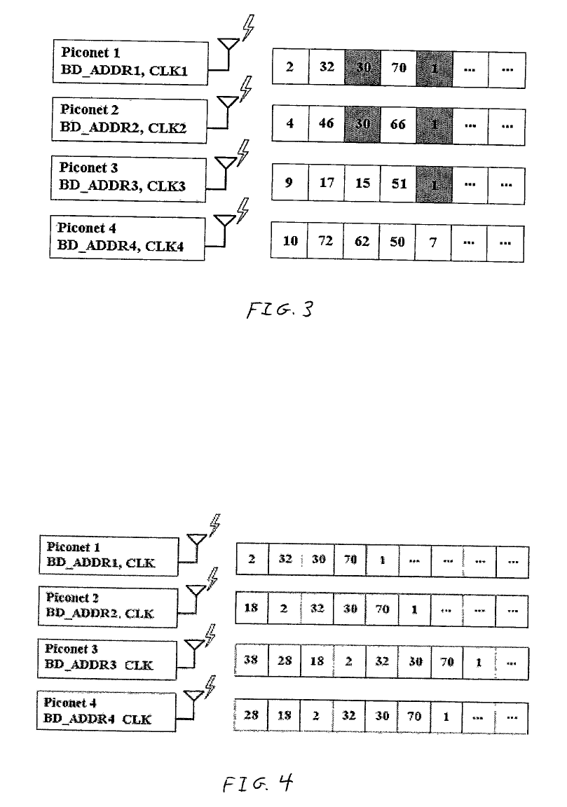

Accordingly, the slot crashing handling engine 650 (FIG. 1) may be necessary for handling such conditions to enhance the efficiency of the system. As discussed below, the slot crashing handling engine 650 detects a same frequency element being selected in the same time slot and works in conjunction with interference control processing to minimize or lessen interference.

Interference Control Algorithm (Processing)

Referring to FIG. 5, interference control processing 500 according to an exemplary preferred embodiment of the present invention is illustrated. At step 502, the next N frequencies are determined for all piconets. For example, four lists of hopping frequencies are computed when there are four piconets. Each hopping frequency sequence consists of, for example, ten pre-computed frequency elements of the upcoming ten slots. At step 504, the slot crashing handling engine 650 (FIG. 1) determines whether there will be any frequency collisions for the hopping frequency sequences just generated by detecting a same frequency element being selected in the same time slot. If two or more lists show the same selected frequency element at the same time slot, a collision will occur soon. If it is determined that there will be no collisions, step 502 is repeated. If it is determined that there will be a frequency collision, the processing advances to step 506 where it is determined when the collision will happen. At step 508, information (such as packet importance indicator) is processed to determine which packet is to be retained. In an exemplary embodiment, according to the packet importance indicator, a specific packet is selected to be scarified. The output of the engine controls the operation of the RF chips (e.g., RTX or LMX3162), on or off. At step 510, one complete transmission is allowed rather than crashing all of the packets of the piconets during the collision time slot. Thus, the interference control processing 500 controls the effect of interference by inhibiting the transmission of packets in all-but-one piconet during the collision time slot.

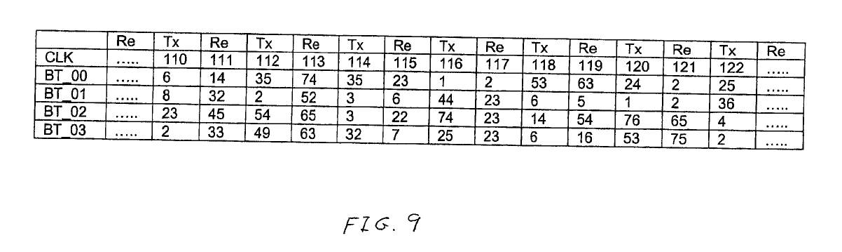

In a preferred embodiment, the present invention involves a rescuing process that can increase system efficiency by lessening the number of retransmission processes needed for each collision time slot. Referring to FIG. 8, interference control processing 800 according to an embodiment of the present invention is illustrated. After the BT masters are setup at initialization step 802, frequency sequence computations occur at step 804. For each piconet under the same hub, a list of hopping frequencies is computed and stored. In a preferred embodiment, these lists can be modified to accommodate different states of operation of masters—although preferably the masters primarily operate in connection state.

Referring to FIG. 9, exemplary lists are shown for BT_00 to BT_04. When CLK=114, BT_01 and BT_02 will transmit with the same frequency band, and their packets will be corrupted. When CLK=117, three piconets (BT_01, BT_02, BT_03) will transmit with the same frequency band, and those three packets will be corrupted. According to the present invention, these collisions are predicted and the appropriate rescuing processes can be activated (before CLK reaches the values of 114 and 117, respectively).

Referring again to FIG. 8, at step 806 priority checking is performed and then at step 808 a rescuing process is implemented. Generally, the function of step 806 is to establish packet importance indicators that can be used to determine which packet in a collision time slot is to be transmitted, which packet transmissions are to be inhibited, which packets are to be saved, which packets are to be retransmitted and in what order, etc. In rescuing one of the “crashing” packets, one or more other packets have to be scarified. The packet importance indicators are employed to make this determination and can take into account a great variety of factors. By way of example, an exemplary preferred packet importance indicator relates to one or more of: packet type, service type, a fairness criterion, and a history of prior connections made. The database 640 (FIG. 1) provides the information for the decision making, e.g., connection time, packet type, service type, link quality, etc.

Packet type: different types of packets vary in length and importance. For DM5 (5 slots), DM3 (3 slots), DM1 (1 slot), the first two are multi-slot packets. Therefore, in a preferred embodiment, the transmission of DM5 is less likely to be blocked than DM3 (which, in turn, is less likely to be blocked than DM1) because, once blocked, it is not efficient to that specific link to retransmit another long multi-slot packet. That is, the packet importance indicator will have a higher value for DM5 packets, and so on.

Asynchronous Connection-Less (ACL) and Synchronous Connection-Oriented (SCO) links are different in the sense that most ACL packets will be protected by packet retransmission. That is, packet retransmission is activated (applied) for failure to transmit. Thus, in a preferred embodiment, to minimize the burden on the link for retransmission, ACL packets are given a higher priority (higher packet importance indicator) than SCO packets.

Also, some control packets are very important to some processes, such as waking up from hold mode, authentication process, key request, Frequency Hopping Synchronization (FHS), etc. In a preferred embodiment, such special function packets are assigned a higher transmission priority.

Service type: different types of services include, for example, real time video, high quality movie preview, high quality songs preview, transaction process, directory viewing, resources hunting, Wireless Application Protocol (WAP) site browsing, etc. Services can vary in importance depending upon their type. For example, high quality video or song preview service types can have a high (or highest) importance indicator value. In a preferred embodiment, the packet importance indicator is adjusted by service type depending upon usage of the service types (applications). The importance of different service types can also relate to the needs, desires and/or preferences of users, system administrators, etc. In a preferred embodiment, different services have importance indicator values (e.g., packet importance indicators) which are tuned or tunable.

Previous history: an exemplary factor in determining the fairness of connections. In a preferred embodiment, fairness criteria can include a variety of factors such as a history of connections made. For example, if a specific link has been blocked for many times before, it is less likely to be blocked later on. In a preferred embodiment, the packet importance indicator pertaining to a fairness criterion is or can be adjusted after each block.

An important aspect of the present invention is the tuning of settings. In a preferred embodiment, the packet importance indicators are tuned, e.g., to accommodate a desired or required Quality of Service (QoS). By way of example, the QoS of the system depends on the number of users. The system has a scheduler to manage the network usage and provide a fair service to all users or, alternatively, to only certain users. When there are a small number of users (less than the number of BT master devices), each master is set up to connect to a different user. Therefore, the whole bandwidth of the BT device is devoted to one or two users. This achieves the high network capacity feature of the hub. When more users connect to the hub, eventually, the bandwidth of each BT master will be shared among users that are connected to the master. In a preferred embodiment, the scheduler program determines which master is responsible for connecting which user by monitoring the bandwidth usage of each master. In other word, the master having the most free resources will connect to a new user. When the number of users exceeds the maximum number of users that the hub can handle simultaneously, the hub can still share the bandwidth among the users by selectively disconnecting a user and then using this free resource to serve other users that are waiting for connection. The scheduler has an algorithm to switch connection between users. In a preferred embodiment, each user's network requirements (e.g. the service type, minimum bit rate, etc.) are stored in the database for the hub which chooses the least demanded channel to switch.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

We claim:

1. A system architecture for facilitating wireless communications between devices, comprising:
A processor configured to implement interference avoidance processing and interference control processing for one or more groups of devices of a packet-communications system, the interference avoidance processing providing different addresses and a common clock for each of the groups of devices to minimize a frequency collision probability for the devices, the interference control processing detecting when a same frequency element is selected for more than one of the devices for a same time slot and implementing rescue processing to save data packets that are going to collide from being lost.

2. The system architecture for facilitating wireless communications between devices of claim 1, wherein at least one of the groups of devices comprises a piconet.

3. The system architecture for facilitating wireless communications between devices of claim 1, wherein the one or more of the groups of devices comprise(s) a plurality of piconets.

4. The system architecture for facilitating wireless communications between devices of claim 1, wherein the interference avoidance processing includes choosing particular address bits to provide the different addresses.

5. The system architecture for facilitating wireless communications between devices of claim 4, wherein the particular address bits comprise A_{1,3,5,7,9}.

6. The system architecture for facilitating wireless communications between devices of claim 1, wherein the rescue processing is performed in consideration of a packet importance indicator.

7. The system architecture for facilitating wireless communications between devices of claim 6, wherein the packet importance indicator relates to packet type.

8. The system architecture for facilitating wireless communications between devices of claim 6, wherein the packet importance indicator relates to service type.

9. The system architecture for facilitating wireless communications between devices of claim 6, wherein the packet importance indicator relates to a fairness criterion.

10. The system architecture for facilitating wireless communications between devices of claim 9, wherein the fairness criterion comprises a history of prior connections made.

11. The system architecture for facilitating wireless communications between devices of claim 1, wherein the packet-communication system is a spread-spectrum, frequency-hopping, short-range packet-communications system.

12. The system architecture for facilitating wireless communications between devices of claim 1, wherein the packet-communication system is compatible with the Bluetooth standard.

13. The system architecture for facilitating wireless communications between devices of claim 1, wherein the packet-communication system is capable of operating in the 2.4-Gbit industrial, scientific and medical (ISM) band.

14. A method for facilitating wireless communications between devices, comprising the step of:
controlling hopping frequency generators for a plurality of groups of communication devices with in range of each other to generate hopping frequency sequences for the groups of communications devices by providing the same clock values and different addresses to the hopping frequency generators.

15. The method for facilitating wireless communications between devices of claim 14, wherein only particular address bits are chosen to provide the different addresses.

16. The method for facilitating wireless communications between devices of claim 15, wherein the particular address bits comprise A_{1,3,5,7,9}.

17. A method for facilitating wireless communications between devices, comprising the steps of:
determining when frequency collisions will occur for a plurality of groups of communication devices within range of each other; and
inhibiting transmission of packets in all but one of the groups of communication devices during a collision time slot.

18. The method for facilitating wireless communications between devices of claim 17, wherein the step of inhibiting transmission of packets is performed in consideration of a packet importance indicator.

19. The method for facilitating wireless communications between devices of claim 18, wherein the packet importance indicator relates to packet type, service type and/or a fairness criterion.

20. The method for facilitating wireless communications between devices of claim 19, wherein the fairness criterion comprises a history of prior connections made.

21. The method for facilitating wireless communications between devices of claim 18, wherein the packet importance indicator is tuned.
